(19) United States
(12) Patent Application Publication
(10) Pub. No.: US 2013/0177266 A1
(43) Pub. Date: Jul. 11, 2013

(54) Readily Ventable Reclosable Flexible Containers

(71) Applicant: Benjamin Paul Mack, Appleton, WI (US)

(72) Inventor: Benjamin Paul Mack, Appleton, WI (US)

(73) Assignee: CURWOOD, INC., Neenah, WI (US)

(21) Appl. No.: 13/346,105

(22) Filed: Jan. 9, 2012

(51) Int. Cl. B65D 33/16; B31B 1/84; B31B 1/64

(52) U.S. Cl. 383/203; 493/189; 383/42; 383/59

(57) ABSTRACT

The present disclosure concerns flexible reclosable containers with a one way valve which provides a means to vent fluids, particularly air, from the interior of container when the repeatedly reclosable closure member, typically a zipper, is in a closed state. It also concerns a process for creating such a valve using a seal bar with voids to create a channel which passes behind the closure member. The valve which is disclosed involves a channel which comprises a central passageway which connects a port which communicates with the environment to a port which communicates with the interior of the package. Also disclosed is the concept of using this valve with a readily removable hermetic seal such that the port intended to communicate the environment initially communicates with the headspace between the reclosable closure member and the hermetic seal but does communicate with the environment when the hermetic seal is removed.

### FIELD OF THE INVENTION

The present invention is concerned with reclosable bags or pouches made from flexible film which have a one way valve system which allows them to vent fluids, particularly trapped air, from the interior of a closed bag or pouch and with an efficient and economic method of manufacturing such bags.

### BACKGROUND OF THE INVENTION

Flexible containers which are more or less sealed against the environment and yet are able to vent fluid such as trapped air from their interiors via a one way valve system are known. Among these are plastic bags used for the storage of food products where there is a concern to control the access of atmospheric oxygen to the stored food items such as those taught by U.S. Pat. No. 4,834,554 to Stetler et al. Also among these are reclosable plastic bags, including some such as U.S. Pat. No. 7,967,509 to Turvey et al., which provide venting which bypasses the closure and including some, such as U.S. Pat. No. 6,116,781 to Skeens which uses a flat channels with ports to the communicating with both the interior and the environment. However, these approaches suffer from certain disabilities including the need for additional manufacturing steps to provide the venting structure and, in some cases insufficient sealing against reverse flow. Thus what is lacking is a structure which provides sufficient sealing against the flow of oxygen from the environment into the container to be suitable for use with containers for food products and is capable of manufacture without requiring further additional steps beyond those normally employed in the manufacture of reclosable food packages, thereby imparting one way venting with a minimum burden on package manufacture. Furthermore, the know reclosable vented containers have the vents in communication with the environment immediately upon initial manufacture and closure. It is typical for such vents to have a port to the environment in a side wall of the package. Some general packaging, such as that taught in the Turvey patent does have venting which accesses the environment via a passage behind the closure which renders the package reclosable but even in that case the exit port is immediately in communication with the environment. Therefore there is a need for packaging for food products which can initially be hermetically sealed upon filling to ensure an acceptable shelf life, but can subsequently be rendered both reclosable and ventable.

### SUMMARY OF THE INVENTION

The present invention involves a readily manufacturable flexible reclosable ventable container in which a one way valve for expelling fluids from the interior while the closure member is closed is provided by a channel that passes through the heat seal which joins a wall of this container to a profile of the closure member. The flexible containers are constructed of a flexible polymeric film which has a readily heat sealable surface. One or more edges of a piece of the film are heat sealed to each other or another piece of the film to yield a container with an open mouth. The open mouth is provided with a closure member which comprises two profiles which interlock to provide a seal which can be repeatedly opened and closed. The closure member is heat sealed to the two walls of the flexible container which define the mouth adjacent to or at the edge of this mouth and a channel is provided in one of these heat seals. The closure member may be heat sealed to both walls simultaneously or sequentially or each profile may be heat sealed to one of the walls and then the two profiles may be interlocked. The channel comprises two ports, one which opens into the interior of the container and another which opens to the environment, and a central passage which connects the two ports and lies between a wall of the container and a profile of the closure member. This central passageway lies entirely within the heat seal and is parallel to the length of the heat seal.

The channel can be conveniently produced by providing appropriately configured gaps in the heat seal bar and then using the heat seal bar to create a heat seal between a wall of the flexible container and one of the profiles of a closure member. The material beneath the gaps in the heat seal bar will not participate in the formation of the heat seal between the wall and the closure member profile thus creating the channel.

The ports and the central passage way of the channel should be configured such that the air in the environment surrounding the container can not readily pass into the container but air or other fluid in the container can pass out if the pressure in the container is greater than the pressure in the surrounding environment. It is preferred that the average person be capable of being able to exert adequate pressure to force out the air or other fluid which surrounds the contents of the container in a few seconds. Generally this means that the ports access the central channel at a substantial distance from each other, that each port is fairly constrained in size and that the central passage has a fairly small cross-section. However, the ports should preferably be sufficiently large that residual fluid such as air can be readily be expelled from the container by pressing upon the container when the closure member is closed. It is preferred that none of the ports penetrate the walls of the container but rather that the ports function by being gaps in the heat seal joining one of the profiles of the closure member to a wall of the container. A good comprise between these two competing requirements is found at port widths between about ½ and ¾ inch. Larger port widths can be accommodated by closing the ports with a fairly weak pressure sensitive adhesive with fairly low peak peel strengths. Peak peel strengths in the neighborhood of about 50 grams/inch have been found to function well.

In a preferred embodiment, the closure member is initially surrounded by a hermetic seal. This is preferably effected by spacing the closure member from the mouth of the container and then heat sealing the mouth of the container to create a headspace above the closure member. In a particularly preferred embodiment, the two container walls contain a stress concentrator such as a notch at a point of juncture of the two walls between the closure member and the hermetic heat seal which facilitates a fracture of both container walls across the container width thus exposing the closure member to the environment. In an especially preferred embodiment, a line of weakness is present in one or both container walls to facilitate this fracture either alone or in conjunction with a stress concentrator.

### BRIEF DESCRIPTION OF THE DRAWINGS

FIG. 1 is a perspective view of a heat seal bar with a cut out section which creates a venting channel.

FIG. 2 is a front elevation of the heat seal bar showing the same venting channel.

FIG. 3 is a bottom elevation of the heat seal bar showing the interior port and the balance of the venting channel as hidden structure.

FIG. 4 is a cross sectional view of a hermetically sealed bag with a venting channel created by the heat seal bar of FIG. 1-3.

FIG. 5 is a cross sectional view of the sealed bag of FIG. 4 along line A-A.

### DETAILED DESCRIPTION OF THE INVENTION

The resealable flexible polymeric container may be constructed of any material which is available in film form and has an outside layer which is heat sealable. It is important that the container walls exhibit sufficient flexibility that facing walls can readily touch below the lower port to aid in the one way valve action. The film from which the container is constructed preferably has a thickness of less than about 10 mils with a thickness between about 3 and 8 mils being particularly preferred in order to exhibit this flexibility. These resealable containers find particular utility for the storage of food items and for such applications container walls made from multilayer films in which one of the layers is an oxygen harrier are preferred. Oxygen harrier layers comprising ethylene vinyl alcohol (EVOH) copolymer or polyvinylidene chloride (PVdC) are particularly preferred. A preferred film structure is an oriented polyester (OPET) which has been extrusion laminated to a heat sealable layer comprising a mixture of EVOH and plastomer (metallocene catalyzed linear low density polyethylene (mLLDPE). A particularly preferred film structure has a layer of low density polyethylene (LDPE) intermediate between the OPET and the sealant layer.

The container may be fabricated by any technique which provides three closed sides and an open mouth which can carry a closure member comprising two interlocking profiles that can be repeatedly interlocked and separated. Included are the techniques of sealing one end of a length of tube stock, sealing the open edge and one end of a length of folded sheet, sealing the two sides of width of folded sheet or sealing three edges of two sheets together. It is simply important that the inner surfaces of the two walls which define the open mouth are readily heat sealable. The interlocking profiles are heat sealed to these inner surfaces at or adjacent to the edges which define the end of the open mouth. The profiles may be interlocked when heat sealed and be heat sealed to the two walls simultaneously or sequentially. Alternatively each profile may be sealed to one of the walls and the two profiles may be subsequently interlocked.

The size of the container is not critical. It preferably ranges from the small bags used for food items like shredded cheese to the large pallet stacked bags for items like pet food. One preferred embodiment is bags with widths between about 3 and 10 inches and heights between 5 and 15 inches.

The closure member may be any of the type known for use in rendering flexible polymer film containers reclosable. These are typically two interlocking profiles which can be repeatedly interlocked and separated. Included are both the press to close zippers and the zippers closed and opened with a slider. These closure members are typically available secured to backing strips which are heat sealable. The two profiles which make up the closure member may be centered on their respective backing strips or may be nearer one edge or the other of these strips (except for the case of the slider zippers, in which, of course, the profiles must be located at the top of the backing strips). It is preferred that the flanges of the backing strip not extend more than about 10 mm below the profile and it is more preferred that they not extend more than about 5 mm.

The channel comprises at least two ports connected by a central passageway with each port entering the central passageway at a point some distance from where the other port enters. At least one port communicates with the interior of the container and another communicates with the environment. It is preferred that the port that communicates with the environment not do so through one of the walls of the container but rather that if the closure member is taken as horizontal, this exit port is generally vertical. The spacing between the exit port and the port communicating with the interior is not critical so long as they are offset from each other. It has been observed that as the distance between the two ports is shortened the delay until air renters the container is shortened. However, as the distance between the ports is lengthened at some point further increases in the distance do not appear to increase the effectiveness of the one way valving effect. It is preferred that the distance between the ports be at least about 3 inches and it is particularly preferred that it be at least about 6 inches.

The height of the central passageway is limited by the width of the heat seal securing the closure member to the wall of the container which carries the channel, as the central passageway lies entirely within this heat seal. Within this constraint, the operation of the one way valve does not appear to be particularly sensitive to changes in this dimension and acceptable operation has been observed at heights between 1 and 2 cm. The width of this heat seal is, of course, limited by the width of the backing strips on the available closure members, which are typically about 1 inch or less.

The size of the ports does have an effect of the operation of the one way valve. The larger the ports the easier it is to expel air from the interior of the container but also the more quickly air will tend to pass back into the hag. The valve operation is more sensitive to the size of the port which communicates with the container interior than to the size of the port which communicates with the environment. It is preferred that the interior ports have a width between about ½ and ¾ inch and it is particularly preferred that the exterior ports also have a width within this range. It is preferred that there be one exterior port and one interior port. Additional ports could potentially provide for additional air flow but air flow is, in any case, limited by the cross section of the central passageway.

It is preferred that the configuration of the channel be such that the average person can expel any air or other fluid which surround any solid contents placed in the container by the application of force with his hands for a few second. It is further preferred that the container does not take up a readily noticeable amount of air over the course of several weeks.

The production of vented containers with which the present invention is concerned is effected by an appropriately profiled heat seal bar. The heat seal bar is designed to leave voids in the heat seal which joins one of the profiles of a closure member to one of the walls of the container at or near the open mouth of the container. These voids comprise the channel which acts as a one way valve for venting air or other fluids from the interior of the container and not allowing the immediate return of the vented fluid. This provides an elegant and efficient method of providing such one way venting which does not require the creation of any additional structures. The creation of channel which effects one way venting is readily incorporated into the production of reclosable containers with flexible polymeric walls without the need for any additional steps.

In a preferred embodiment, the profiled heat seal bar is used to secure the closure member to a container wall at some distance from the open end of the wall and an unprofiled heat seal bar secures the closure member to the other wall of the container leaving a head space above the closure member. The exterior port then communicates with this head space. The open ends of the walls are then heat sealed together to give the container a hermetic seal. Some structure is then provided to facilitate a line of fracture through one or both of the container walls. It may be a stress concentrator such as a notch or a line of weakness such as a score or both.

A container is thus provided which, because of its hermetic seal, is suitable for the storage of food items, such as shredded cheese, for an extended period. Once this hermetic seal is destructively removed, the consumer of the contents of the container is left with a reclosable container which can be manipulated to expel air or other fluids from the container interior without opening the closure member. However, this venting capability has been configured such that it allowed the initial formation of a hermetically sealed container without the use of involved venting structures. In addition, the venting mechanism is rendered active without the need to take any steps beyond those involved in the initial opening of the container.

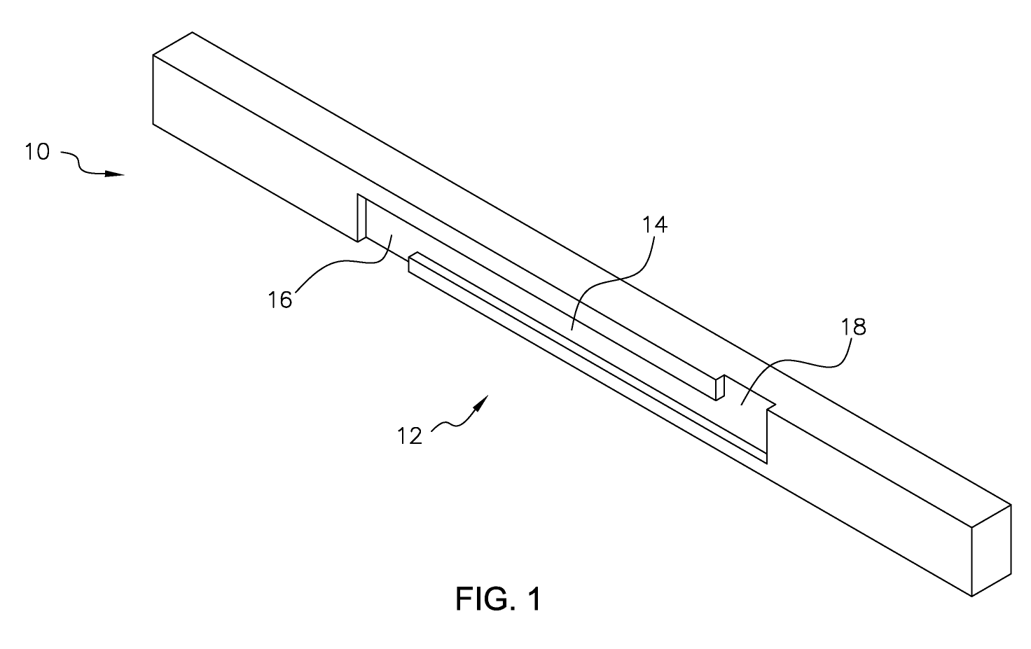

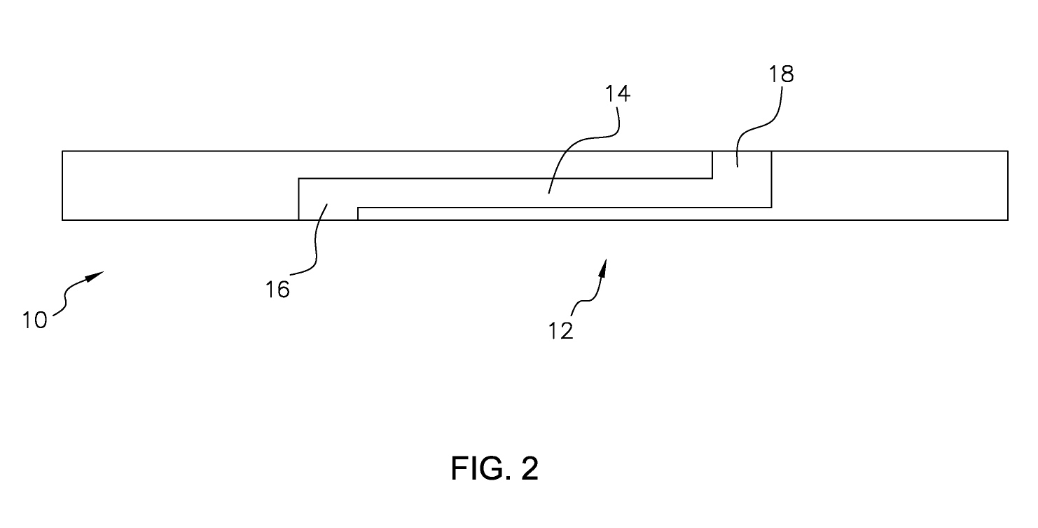

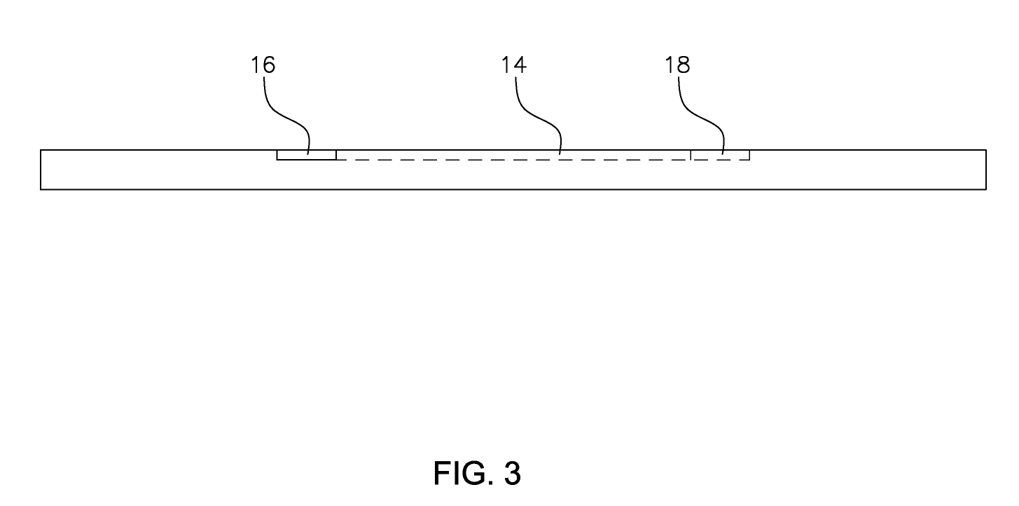

FIG. 1 illustrates a heat seal bar 10 which is configured with a void which yields the venting channel 12. It comprises a central passageway 14 which connects an interior port 16 to an exterior port 18. As can most clearly appreciated from FIG. 2 and FIG. 3 this heat seal bar will create a central passageway 14 which is buried within a heat seal and runs generally parallel to the length of the heat seal and communicates with the interior and the environment via vertical ports 16 and 18, respectively.

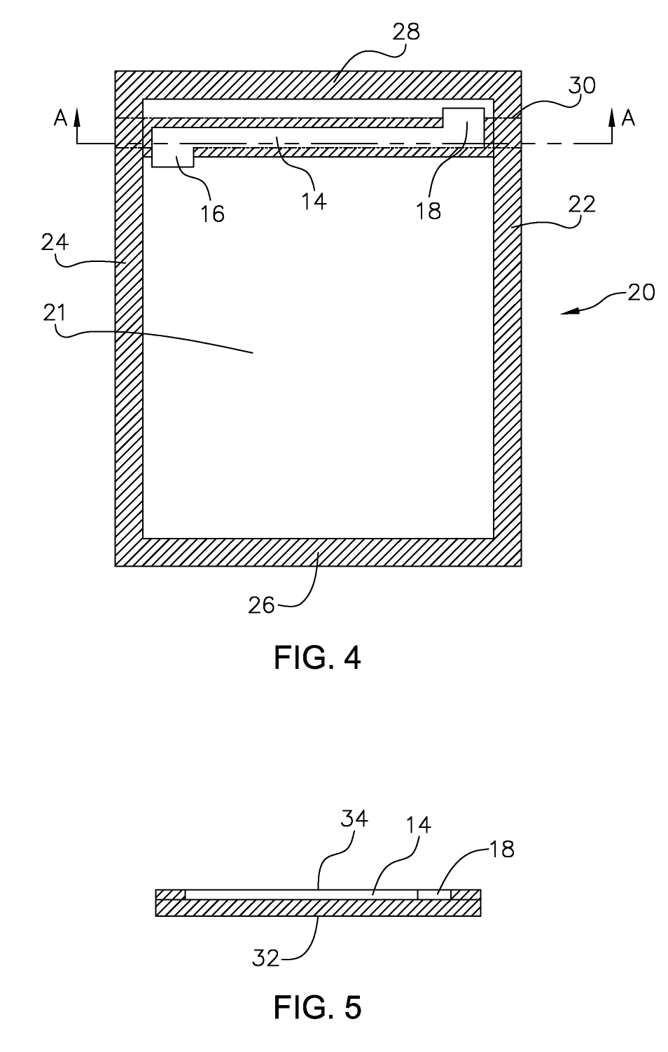

The line of fluid communication from the interior 21 of a hag 20 having sealed side wall 22 and 24 and a bottom seal 26 is illustrated in FIG. 4 to be from the interior vertically oriented port 16 to the horizontally oriented central passageway 14 and from that passageway 14 to the vertically oriented exterior port 18. Also illustrated in FIG. 4 is the one time removable hermetic seal 28 which can be destructively removed from the hag 21 by a fracture along the line of weakness 30 in the front and back walls of the bag 32 and 34, respectively.

The relative placement of the central passageway 14 and the exterior port 18 to the closure member 36 and the front wall 32 and the back wall 34 is illustrated in FIG. 5.

### WORKING EXAMPLES

### Example 1

A flexible polymer bag adapted to the storage of shredded cheese was made by heat sealing two polymer sheets 6¾ inches by 9½ inches to each other at three of their peripheral edges leaving an open mouth across the 6¾ inch dimension. The sheets were each cut from a 3 mil three layer film made by extrusion laminating an approximately 0.5 mil oriented polyester to a low density polyethylene which in turn is extrusion laminated to an extrusion blend of ethylene vinyl alcohol copolymer with plastomer (metallocene polymerized linear low density polyethylene). This layer displayed oxygen harrier properties and was readily heat sealable.

A press to close zipper with each profile carrying an approximately 2.2 cm wide backing strip was heat sealed to one wall of the open mouth via one of the backing strips and then the opposite wall was heat sealed to the other backing strip. The zipper sat on its backing strip with 14 mm extending above the zipper and 3 mm extending below the zipper. The zipper was about 5 mm in height and was about 10 mil thick.

The heat seal bar used to form the first heat seal to the zipper was configured to create a channel in the heat seal which it created. The channel was centered in the heat seal and extended 6 inches. The channel's central passageway was located 0.16 inches above the bottom of the heat seal. At one end was a port ¾ inches wide which penetrated through the bottom of the heat seal and at the other end was a port ¾ inches wide which penetrated through the top of the heat seal. The central passageway was 0.37 inches in height.

The bag was partially filled with shredded cheese and then the two profiles of the press to close zipper were interlocked to close the open mouth of the bag. The bag was then compressed to force of the air surrounding the cheese. The air flowed out smoothly with the application of digital force well within the capability of the average person. The outflow just required a few seconds. The bag was observed over the course of several weeks and no appreciable air uptake was observed.

### Example 2

An evaluation was made of varying the size of the two ports using the same construction as described in Example 1. In some cases a pressure sensitive adhesive, Elmer's glue stick, was applied to the walls of the ports to give a peak opening resistance of about 50.76 grams per inch and an average opening resistance of about 25.36 grams per inch. In these cases the adhesive resealed the ports without the application on any pressure once the expulsion of air from the bag was terminated. The bags were evaluated 24 hours and one week after air was expelled with the criterion being whether there had been a readily noticeable uptake of environmental air.

| Top | Bottom | | | | |
|---|---|---|---|---|---|
| Port | Port | Adhe- | 24 Hour | One Week | |
| Width in | Width in | sive | Evalua- | Evalua- | |
| Inches | Inches | Used | tion | tion | Notes |
| ¼ | ¼ | No | No Uptake | No Uptake | Difficulty in |
| | | | | | expelling air |
| ½ | ½ | No | No Uptake | No Uptake | Air readily |
| | | | | | expelled |
| ¾ | ½ | No | No Uptake | No Uptake | |
| ¾ | ¾ | No | No Uptake | Observ- | |
| | | | | able | |
| | | | | Uptake | |
| 1 | 1 | No | Observ- | Observ- | |
| | | | able | able | |
| | | | Uptake | Uptake | |
| 1 | 1 | Yes | No Uptake | No Uptake | |
| 1⅛ | 1⅛ | Yes | No Uptake | No Uptake | |

### Example 3

A series of eight press to close zippers were evaluated using the same general construction as in Example 1 with both ports being ½ inch in width and without the use of adhesive. All of these bags displayed no readily noticeable uptake of environmental air one week after the air in the hag was expelled. The zippers all had a profile thickness of about 10 mils.

| Height of Flange | Height of Zipper | Height of Flange |
|---|---|---|
| Above Profile | Profile | Below Profile |
| in Millimeters | in Millimeters | in Millimeters |
| 4 | 2 | 13 |
| 3 | 3 | 7 |
| 6 | 2 | 9 |
| 1 | 2 | 12 |
| 4 | 2 | 9 |
| 3 | 2 | 7 |
| 5 | 3 | 5 |
| 13 | 2 | 4 |

### Example 4

A bag with the same general construction as in Example 1 but with a top slider zipper and top and bottom port widths of 1½ inches was evaluated. The zipper profile had a thickness of about 10 mil and a height of ¼ inch with a flange extending ¾ inches below the profile. No adhesive was used on the port walls. There was no readily noticeable uptake 24 hours after the expulsion of air from the bag but there was readily noticeable uptake of environmental air after one week.

The above disclosure is for the purpose of illustrating the present invention and should not be interpreted as limiting the present invention to the particular embodiments described but rather the scope of the present invention should only be limited by the claims which follow and should include those modifications of what is described which would be readily apparent to one skilled in the art.

What is claimed is:

1. A resealable flexible polymeric container for the storage of food products comprising;
a. Two panels of a flexible polymer which are connected to each other by simple continuation of material and/or a heat seal at three of their peripheral edges to form a container with an open mouth through which the contents of the pouch may be removed;
b. A reclosable structure comprising two profiles facing each other, each of which is connected to one of said panels such that when the profiles engage with one another they seal said open mouth, said structure located adjacent to but not at the terminal ends of said panels which form said open mouth;
c. A hermetic seal at the terminal ends of said panels which form said open mouth which forms an airtight barrier between the environment and the interior of said pouch;
d. A stress concentrator such as a notch located between said hermetic seal and said reclosable structure in such a way as to facilitate the removal of said hermetic seal by fracturing said panels along a line generally parallel to said reclosable structure;
e. A one way valve which allows fluids to flow from the interior of said pouch to the environment when the hermetic seal has been removed and the fluid has a greater pressure than the atmosphere surrounding said pouch, said valve comprising:
i. A narrow thin channel adjacent to the interior surface of one of said panels;
ii. A first port communicating with the interior of said pouch; and
iii. A second port communicating with the space between the exterior of said reclosable structure and said hermetic seal such that said second port only communicates with the environment when the hermetic seal has been removed.

2. The container of claim 1 wherein said one way valve comprises a channel in polymeric material that lies between one of said panels and one of the profiles of said reclosure structure with said first port being a vertical aperture into said channel which communicates with said pouch interior and with said second port being a vertical aperture into said channel that communicates with the space between said panels on the outside of said closure structure.

3. The container of claim 1 wherein said hermetic seal is a heat seal and a line of weakness extends from said stress concentrator across both panels.

4. The container of claim 1 wherein two panels of a flexible polymer which are heat sealed to each other at three of their peripheral edges.

5. The container of claim 1 wherein when a solid material is placed in the container and the hermetic seal is not in place the air surrounding said solid material can be expelled by an average person applying force with his hand for a few second and the container and the container does not take up a readily noticeable amount of air over the course of several weeks.

6. A process of making a reclosable flexible polymeric container for the storage of items with a one way valve for venting fluids from the container comprising heat sealing a pair of closure profiles, said profiles releasably interlocking to provide reclosability to said container, to the walls of said container which define the open mouth of said container wherein the heat seal between one of said walls and one of said profiles is configured to contain a narrow channel which is capable of providing communication between the interior of said container and the environment, said channel comprising a main portion which extends generally parallel to the length of said heat seal and two ports spaced along the length of said channel with one communicating with the interior of said container and the other communicating with the environment, said channel being so configured that it only facilitates fluid communication between said ports when the pressure inside said container is greater than the pressure in the environment.

7. The process of claim 6 wherein the port communicating with said interior is configured such that it is closed by said container walls coming in contact with each other when the pressure in said interior does not exceed the pressure in the environment.

8. The process of claim 6 wherein the channel in said heat seal is created by a profile in a heat seal bar.

9. The process of claim 8 wherein said closure profiles comprise a press to close zipper and the profile behind which said channel extends has a flange which extends into the interior of said container.

10. The process of claim 8 wherein the walls of said container are between 2 and 10 mils thick.

11. The process of claim 8 wherein said profiles, when interlocked, space the portions of the opposing container walls to which they are attached from each other by more than about 10 mils.

12. The process of claim 6 wherein the walls which define said open mouth extend beyond where they are heat sealed to said profiles, the terminal edges of said walls are sealed to each other to create a hermetic seal and some feature is included in the portion of said walls between said hermetic seal and said closure profiles which facilitates the fracture of said walls.

13. The reclosable flexible polymeric container made by the process of claim 6.

14. The reclosable flexible polymeric container made by the process of claim 13.
